(19) United States
(12) Patent Application Publication
(10) Pub. No.: US 2014/0030384 A1
(43) Pub. Date: Jan. 30, 2014

(54) WHEY PROTEIN- AND GLYCINE-CONTAINING COMPOSITIONS

(71) Applicant: Franco Cavaleri, Surrey (CA)

(72) Inventor: Franco Cavaleri, Surrey (CA)

(21) Appl. No.: 13/953,210

(22) Filed: Jul. 29, 2013

Related U.S. Application Data
(60) Provisional application No. 61/676,970, filed on Jul. 29, 2012.

(51) Int. Cl. A23L 1/305

(52) U.S. Cl. CPC A23L 1/3056
USPC 426/72; 426/580

(57) ABSTRACT

Compositions are disclosed that include undenatured whey protein and glycine. The undenatured whey protein is preferably included at a final concentration of about 20%-80%, while the glycine is present at a final concentration of about 5%-35%. The whey protein has not been exposed to acid hydrolysis and, preferably, includes cold cross-flow membrane filtrate. The glycine is preferably 20-80 mesh in size, and exhibits a U.S. Pharmacopeia (USP) 28 grade. The composition further includes several vitamin and mineral cofactors, namely, selenomethionine, nicotinamide adenine dinucleotide (NADH), and Vitamin B3.

### CROSS-REFERENCE TO RELATED APPLICATIONS

This application claims priority to U.S. provisional patent application Ser. No. 61/676,970, filed on Jul. 29, 2012.

### FIELD OF THE INVENTION

The field of the present invention relates to combinations of whey protein, glycine, and certain vitamin and mineral cofactors, along with methods of using such compositions for health and nutritional purposes.

### BACKGROUND OF THE INVENTION

The need for health-enhancing nutraceutical and dietary supplement compositions has continued to grow over the past couple of decades. Indeed, the average human diet is often deficient in many key food ingredients and, more particularly, such diets often contain insufficient amounts of certain vitamins, minerals, and proteins that a healthy person should consume on a daily basis. Supplemental vitamins and nutraceuticals can fill this void, for the purpose of satisfying basic nutritional needs, preventing or ameliorating mal health effects, muscle building, or for other purposes.

However, the currently-available nutritional supplements and nutraceuticals that contain a desirably high level of protein often exhibit an undesirable taste, which renders such products less appealing to consumers (despite the otherwise significant health benefits that may be gained from such products). Accordingly, there is a continued need in the marketplace for nutritional supplements and nutraceuticals that contain a desirably high level of protein (and other important vitamins and minerals), while simultaneously exhibit a more appealing flavor profile.

As explained further below, the present invention addresses such needs in the marketplace, along with others.

### SUMMARY OF THE INVENTION

According to certain aspects of the present invention, compositions are provided that comprise undenatured whey protein and glycine. The invention provides that the undenatured whey protein is preferably included at a final concentration of about 20%-80%, whereas the glycine is present at a final concentration of about 5%-35%. The invention provides that the whey protein will not have been exposed to acid hydrolysis and, preferably, comprises cold cross-flow membrane filtrate. The invention provides that the glycine is preferably 20-80 mesh in size, and exhibits a U.S. Pharmacopeia (USP) 28 grade.

The compositions of the present invention optionally (albeit preferably) further comprise particular vitamins and minerals, namely, selenomethionine, nicotinamide adenine dinucleotide (NADH), and Vitamin B3. The invention provides that each of the selenomethionine, nicotinamide adenine dinucleotide, and Vitamin B3 are preferably present at a final concentration between 0.1%-1% (and, furthermore, that a greater amount of nicotinamide adenine dinucleotide is present than Vitamin B3, and a greater amount of Vitamin B3 is present than selenomethionine).

The invention provides that the compositions of the claimed invention may be used to impart a variety of different advantageous health benefits, particularly those described below.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

According to certain preferred embodiments, the present invention is a composition that comprises undenatured whey protein and glycine. The invention provides that the whey protein is undenatured, agglomerated, and has not been subjected to acid hydrolysis (which is a treatment that is otherwise commonly applied to whey protein that is formulated into nutritional supplement products). More particularly, the undenatured whey protein preferably comprises cold cross-flow membrane filtrate, in order to avoid any heat exposure to the protein (and to preserve native protein configuration). In addition, as explained above, the compositions of the present invention further comprise purified glycine. More particularly, the purified glycine is preferably 20-80 mesh in size, and U.S. Pharmacopeia (USP) 28 grade.

The invention provides that the undenatured whey protein and glycine components are present within certain preferred ranges of concentrations. More specifically, the invention provides that the whey protein is preferably present at a final concentration of about 20%-80%, whereas the glycine is preferably present at a final concentration of about 5%-35%. For example, for a composition that is manufactured to a final mass of about 50 grams, the composition will preferably comprise about 10-40 grams (20%-80%) of undenatured whey protein and 2.5-17.5 grams (5%-35%) of glycine.

According to certain preferred embodiments, the compositions of the present invention may, optionally, further comprise particular vitamin and mineral cofactors. Specifically, the compositions of the present invention may comprise selenomethionine, nicotinamide adenine dinucleotide (NADH), Vitamin B3 (niacin and not niacinamide), or various combinations of such cofactors. In certain preferred embodiments, the composition will contain all three of such cofactors. In such embodiments, the invention provides that the selenomethionine, nicotinamide adenine dinucleotide, and Vitamin B3 are present at a final concentration between 0.1%-1%. Still further, according to certain preferred embodiments, the invention provides that a greater amount of nicotinamide adenine dinucleotide is present than Vitamin B3, and a greater amount of Vitamin B3 is present than selenomethionine. Referring back to the example above, for a composition that is manufactured to a final mass of about 50 grams, the composition will preferably comprise about 10-150 micrograms of selenomethionine, 0.3-20 milligrams of nicotinamide adenine dinucleotide, and 0.1-10 milligrams of Vitamin B3.

There are many health benefits provided by the compositions of the present invention. In the case of the whey protein, this component provides the following important characteristics and benefits to the compositions described herein: antioxidant properties, improved immune responses, nutritional benefits, appetite modulation, chelating activity (for toxic metal clearance), dental health, cardiovascular health, stress tolerance, enhanced mental acuity, bone health, intestinal health, lean muscle growth, and others.

Similarly, the glycine component of the present invention plays an important role in the performance of the composition. More particularly, glycine imparts the following key attributes to the composition: an important component of glutathione synthesis, supports glutathione saturation, immune system support, antioxidant and hepatoprotectant qualities, supports anabolism for muscle growth, supports anticatabolic activity (to help prevent muscle and tissue breakdown under stress), combats hypoglycemia, supports glycogen storage for stamina, provides a precursor for creatine and glutathione synthesis, supports wound healing, improves mind and body energy, supports a healthy psychology and mood, anti-inflammatory properties, cytoprotective properties, helps protect kidneys, provides soothing attributes for gastrointestinal surfaces, protects against stomach ulcers, supports hormone output, provides mind calming attributes, detoxifying properties against sepsis and general toxicity, and improves muscle volume, strength, and development.

In addition to the foregoing advantages provided by the glycine component, the invention provides that the glycine further improves the solubility of the whey protein, improves flavor, and imparts a desirable sweetness to the composition (without compromising the protein content or other health qualities of the composition). Importantly, the glycine imparts a desirable sweetness to the composition without the need to introduce artificial sweeteners, thereby allowing the composition to be characterized as “all natural.” The glycine also imparts a more desirable viscosity and density to the composition (for mixing purposes).

In addition to the benefits provided by the whey protein and glycine, the vitamin and mineral cofactors referenced above provide yet further beneficial qualities to the composition. Specifically, these cofactors are effective to facilitate the synthesis of glutathione, in cooperation with the whey protein and glycine components. In addition, the cofactors are effective to encourage the recycling of oxidized glutathione—back to its active and reduced state.

The invention further provides that the whey/glycine compositions of the present invention may be administered in any desired and effective manner, e.g., as nutritional supplements for oral ingestion. It will be appreciated that such nutritional supplements may be formulated as, for example, powders, capsules, tablets, suspensions, etc. Of course, additional substances may be included in the compositions of the present invention to provide additional desired properties, such as preservatives. Non-limiting examples of preservatives include natural or synthetic chemicals that are added to hinder spoilage, whether caused by microbial growth, or unwanted chemical changes such as, but not limited to, hydrolysis or oxidation. Suitable preservatives may include, but are not limited to, benzoic acid, sorbic acid, benzyl alcohol, benzethonium chloride, butyl paraben, cetrimide, chlorobutanol, cresol, ethyl paraben, phenol, phenoxyethanol, propylene glycol, sodium benzoate, thimersol, methyl paraben, propyl paraben, or mixtures thereof.

Still further, the compositions may further comprise one or more acceptable ingredients, which must be “acceptable” in the sense of being compatible with the other components of the composition (and not injurious to the consumer). Non-limiting examples of such ingredients include (1) fillers or extenders, such as starches, lactose, sucrose, glucose, mannitol, and silicic acid; (2) binders, such as carboxymethylcellulose, alginates, gelatin, polyvinyl pyrrolidone, hydroxypropylmethyl cellulose, sucrose and acacia; (3) humectants, such as glycerol; (4) disintegrating agents, such as agar-agar, calcium carbonate, potato or tapioca starch, alginic acid, certain silicates, sodium starch glycolate, cross-linked sodium carboxy methyl cellulose and sodium carbonate; (5) solution retarding agents, such as paraffin; (6) absorption accelerators, such as quaternary ammonium compounds; (7) wetting agents, such as cetyl alcohol and glycerol monosterate; (8) absorbents, such as kaolin and bentonite clay; (9) lubricants, such as talc, calcium stearate, magnesium stearate, solid polyethylene glycols, and sodium lauryl sulfate; (10) suspending agents, such as ethoxylated isostearyl alcohols, polyoxyethylene sorbitol and sorbitan esters, microcrystalline cellulose, aluminum metahydroxide, bentonite, agar-agar and tragacanth; (11) buffering agents; (12) excipients, such as lactose, milk sugars, polyethylene glycols, animal and vegetable fats, oils, waxes, paraffins, cocoa butter, starches, tragacanth, cellulose derivatives, polyethylene glycol, silicones, bentonites, silicic acid, talc, salicylate, zinc oxide, aluminum hydroxide, calcium silicates, and polyamide powder; (13) inert diluents, such as water or other solvents; (14) preservatives; (15) surface-active agents; (16) dispersing agents; (17) control-release or absorption-delaying agents, such as hydroxypropylmethyl cellulose, other polymer matrices, biodegradable polymers, liposomes, microspheres, aluminum monosterate, gelatin, and waxes; (18) opacifying agents; (19) adjuvants; (20) wetting agents; (21) emulsifying and suspending agents; (22), solubilizing agents and emulsifiers, such as ethyl alcohol, isopropyl alcohol, ethyl carbonate, ethyl acetate, benzyl alcohol, benzyl benzoate, propylene glycol, 1,3-butylene glycol, oils (in particular, cottonseed, groundnut, corn, germ, olive, castor and sesame oils), glycerol, tetrahydrofuryl alcohol, polyethylene glycols and fatty acid esters of sorbitan; (23) propellants, such as chlorofluorohydrocarbons and volatile unsubstituted hydrocarbons, such as butane and propane; (24) antioxidants; (25) agents which render the formulation isotonic with the blood of the intended recipient, such as sugars and sodium chloride; (26) thickening agents; (27) coating materials, such as lecithin; and (28) sweetening, flavoring, coloring, perfuming and preservative agents. Ingredients and materials suitable for a selected dosage form and intended route of administration are well known in the art, and acceptable ingredients and materials for a chosen dosage form and method of administration may be determined using ordinary skill in the art.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A composition that comprises undenatured whey protein and glycine, wherein the undenatured whey protein is present at a final concentration of about 20%-80% and the glycine is present at a final concentration of about 5%-35%.

2. The composition of claim 1, which further comprises selenomethionine.

3. The composition of claim 1, which further comprises nicotinamide adenine dinucleotide.

4. The composition of claim 1, which further comprises Vitamin B3.

5. The composition of claim 1, which further comprises selenomethionine, nicotinamide adenine dinucleotide, and Vitamin B3.

6. The composition of claim 5, wherein each of the selenomethionine, nicotinamide adenine dinucleotide, and Vitamin B3 are present at a final concentration between 0.1%-1%.

7. The composition of claim 6, wherein a greater amount of nicotinamide adenine dinucleotide is present than Vitamin B3, and a greater amount of Vitamin B3 is present than selenomethionine.

8. The composition of claim 7, wherein the whey protein has not been exposed to acid hydrolysis and comprises cold cross-flow membrane filtrate.

9. The composition of claim 8, wherein the glycine is 20-80 mesh in size, and exhibits a U.S. Pharmacopeia (USP) 28 grade.

10. A composition that is manufactured to a total mass of 50 grams, which comprises:
(a) 10 grams-40 grams of undenatured whey protein;
(b) 2.5 grams-17.5 grams of glycine;
(c) 10 micrograms-150 micrograms of selenomethionine;
(d) 0.3 milligrams-20 milligrams of nicotinamide adenine dinucleotide; and
(e) 0.1 milligrams-10 milligrams of Vitamin B3.

11. The composition of claim 10, wherein the whey protein has not been exposed to acid hydrolysis and comprises cold cross-flow membrane filtrate.

12. The composition of claim 11, which is manufactured to a total mass that is more or less than 50 grams, wherein the range ratios set forth in claim 10(a)-10(b) are maintained.

13. The composition of claim 12, wherein the glycine is 20-80 mesh in size, and exhibits a U.S. Pharmacopeia (USP) 28 grade.
